(19) United States
(12) Patent Application Publication
(10) Pub. No.: US 2015/0228257 A1
(43) Pub. Date: Aug. 13, 2015

(54) ELECTRONIC DEVICE

(71) Applicant: FUNAI ELECTRIC CO., LTD., Osaka (JP)

(72) Inventor: Satoshi Shimoda, Osaka (JP)

(73) Assignee: FUNAI ELECTRIC CO., LTD., Osaka (JP)

(21) Appl. No.: 14/618,610

(22) Filed: Feb. 10, 2015

(30) Foreign Application Priority Data
Feb. 10, 2014 (JP) 2014-023130

(51) Int. Cl. G09G 5/391; G06T 1/60

(52) U.S. Cl. CPC G09G 5/391; G06T 1/60; G09G 2360/02; G09G 2340/0435; G09G 2340/0457

(57) ABSTRACT

An electronic device includes a memory that stores setting information corresponding to at least identification information and a processor that changes a setting of the electronic device based on setting information corresponding to predetermined identification information in a standby mode. The processor may not output audio in the standby mode.

### BACKGROUND

1. Technical Field

The present invention relates generally to an electronic device for outputting a video, and to a video output device able to change the setting values.

2. Related Art

Conventional video output devices such as display devices allow users to change setting information for video quality, audio quality, and the like. Moreover, conventional video output devices have a last memory function for storing setting information when the power supply is turned OFF (when in standby). This last memory function records in the memory the most recent setting information for the video output device at the time that the power supply is turned OFF. As a result, when the power supply of the video output device is turned ON, the setting information that is recorded in memory is read out to restore the most recent settings from prior to the power supply being turned OFF.

Moreover, in conventional video output devices, the audio volume immediately prior to the power supply being turned OFF is stored in the memory and, when the power supply is turned OFF (when a standby mode is entered), the audio volume that is stored in memory is displayed (see, for example, Patent Reference 1).
Patent Reference 1: Japanese Unexamined Patent Application Publication 2012-257171

### SUMMARY

However, conventional video output device equipped with a last memory function may require the user to adjust to the setting of the video output device after the video output device has been activated. That is, when a plurality of users use the video output device, the video output device setting stores, in the last memory function, that which is most current at the time that the power supply is turned OFF. Thus, a user who does not like this setting may be required to change the setting after the video output device has been activated.

A video output device according to one or more embodiments of the present invention implements a desired setting for a user without performing an operation in order to change the setting after the device is activated.

According to one or more embodiments of the present invention, a video output device for outputting video comprises: a recording portion for recording first setting information, which is setting information prior to a transition into a standby mode, and second setting information, which is associated with the identification information indicating a user; an evaluating portion for evaluating whether or not there is an input of identification information; and a setting portion for performing a setting when transitioning into the active mode, based on the second setting information when the video output device transitions from the standby mode to the active mode when there is an evaluation that identification information has been inputted, and for performing a setting, when transitioning to the active mode, based on the first setting information when the video output device transitions into the active mode from the standby mode when there has been an evaluation that identification information has not been inputted.

According to the configuration as set forth above, for example, if the evaluating portion evaluates that identification information has been inputted, then the setting portion may perform the setting based on the second setting information that corresponds to the identification information when the video output device transitions from the standby mode to the active mode. On the other hand, if the evaluating portion evaluates that identification information has not been inputted, then the setting portion may perform the setting based on the first setting information when the video output device transitions from the standby mode to the active mode.

As a result, the settings desired by the user may be implemented without the user changing the settings after the device has been activated.

According to one or more embodiments of the present invention, the recording portion is not required to be structured from a single physical component, such as a memory, but maybe structured from a plurality of components, such as a collection of a plurality of memories.

According to one or more embodiments of the present invention, the setting information includes settings relating to the operation of the video output device, including, for example, video quality, audio quality, display settings, etc.

One or more embodiments of the present invention may also include a registering portion for receiving an operation input from the user to record, into the recording portion, the second setting information.

According to this configuration, for example, it may be possible to register the second setting information that is set up by the user, thus enabling the settings for the time of activation as desired by the user to be those that are desired by the user.

According to one or more embodiments of the present invention, the evaluating portion may receive an operation input from the user and evaluates that identification information has been inputted in combination with the operation input that has been received.

The configuration as described above, for example, may enable enhanced operability through the ability for the identification information to be set through a combination of operation inputs.

According to one or more embodiments of the present invention, the recording portion may have a removable external memory for storing the second setting information, and the evaluating portion evaluates that identification information has been inputted if the second setting information is recorded in the external memory.

Thus, one or more embodiments may be applied even in cases where setting information for individual users is recorded on an external memory, which may enable an enhancement in convenience for the users.

According to one or more embodiments of the present invention, the evaluating portion may receive an operation input from a mobile terminal through a LAN, and the identification information is an identification ID that is included in a command that is sent from the mobile terminal.

Thus, one or more embodiments of the present invention may be achieved through a command that is sent from a mobile terminal.

One or more embodiments of the present invention may include an audio outputting portion for performing an audio output and an image outputting portion for outputting an image, where the first setting information and the second setting information includes at least a setting for audio that is to be outputted from the audio outputting portion and/or setting for an image that is to be outputted from the image outputting portion.

Thus, one or more embodiments may be applied to settings for video quality and for audio quality.

One or more embodiments of the present invention may include a displaying means for displaying electronic program guides, where the first setting information and the second setting information are information for selecting a channel displayed by the displaying means.

Thus, one or more embodiments may be applied to set up and display electronic program guides.

While one or more embodiments of the present invention may be provided as a device unit, one or more may alternatively be provided as a system that is equipped with the structures of one or more embodiments of the present invention, or provided as a method according to one or more embodiments of the present invention.

### BRIEF DESCRIPTION OF THE DRAWINGS

FIG. 1 shows an external view of a displaying device according to one or more embodiments of the present invention.

FIG. 2 shows a functional block diagram for explaining the functions of a displaying device according to one or more embodiments of the present invention.

FIG. 3A shows an explanation of changes when the displaying device transitions from a standby mode to an active mode according to one or more embodiments of the present invention.

FIG. 3B shows an explanation of changes when the displaying device transitions from a standby mode to an active mode according to one or more embodiments of the present invention.

FIG. 4 shows a block diagram for explaining a hardware structure for the displaying device according to one or more embodiments of the present invention.

FIG. 5 shows a flowchart illustrating the procedures executed by a recording portion of the displaying device according to one or more embodiments of the present invention.

FIG. 6A shows a diagram illustrating a screen that is displayed on the displaying device according to one or more embodiments of the present invention.

FIG. 6B shows a diagram illustrating a screen that is displayed on the displaying device according to one or more embodiments of the present invention.

FIG. 7 shows a flowchart for explaining the procedures that are executed in response at the time of activation of the displaying device according to one or more embodiments of the present invention.

FIG. 8A shows a diagram for explaining the changes in the settings in the displaying device according to one or more embodiments of the present invention.

FIG. 8B shows a diagram for explaining the changes in the settings in the displaying device according to one or more embodiments of the present invention.

FIG. 9 shows a diagram for explaining second setting information and standard setting information related to the identification information in the displaying device according to one or more embodiments of the present invention.

FIG. 10 shows a diagram for explaining second setting information and third setting information related to the identification information in the displaying device according to one or more embodiments of the present invention.

FIG. 11 shows a block diagram for explaining the hardware structure of a displaying device according to one or more embodiments of the present invention.

FIG. 12 shows a flowchart for explaining the procedures that are executed when activating the displaying device according to one or more embodiments of the present invention.

FIG. 13 shows an external view of a video output system according to one or more embodiments of the present invention.

FIG. 14 shows a diagram illustrating a structure of a command that is outputted from a mobile terminal according to one or more embodiments of the present invention.

FIG. 15 shows a flowchart for explaining procedures that are executed when activating a displaying device according to one or more embodiments of the present invention.

FIG. 16 shows a diagram for explaining history information a viewing time band related to the identification information in the displaying device according to one or more embodiments of the present invention.

### DETAILED DESCRIPTION

Embodiments of the present invention will be explained below, with reference to the drawings, in the following sequence:

1. First Example:
(1) Structure of the Video Output Device
(2) Method for Registering Setting information
(3) Activating Method

2. Second Example

3. Third Example

4. Other Examples

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### 1. First Example

### (1) Structure of the Video Output Device According to One or More Embodiments of the Present Invention

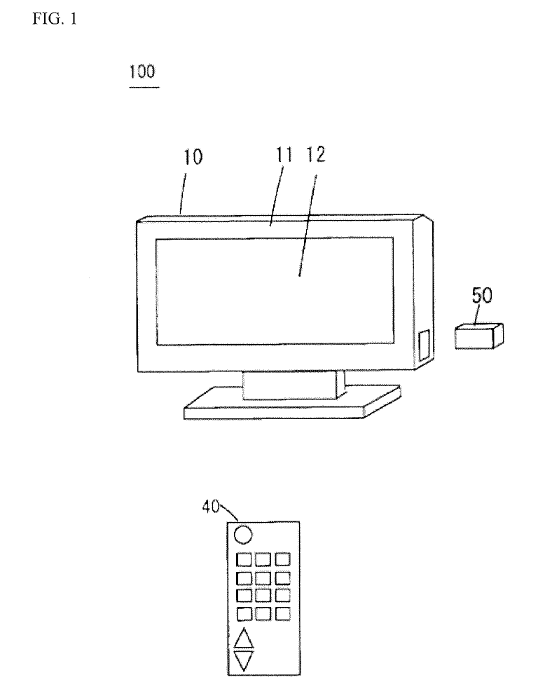

In this first example, the explanation will use a displaying device 10 as a video output device. FIG. 1 shows an external view of the displaying device 10 according to one or more embodiments of the present invention. In the examples below, the displaying device 10 as the video output device is an example of an electronic device.

The displaying device 10 is arranged so that a display panel 12, which displays a video, is exposed on front surfaces of a case 11. Moreover, the displaying device 10 may comprise a remote control device 40. The user is able to operate the remote control device 40 to send, to the displaying device 10, commands for turning ON/OFF the power supply for the displaying device 10. Here, the state in which the power supply for the displaying device 10 is turned OFF will be described as the “standby mode.” In the standby mode, the displaying device 10 monitors for a command (input) from the remote control device 40, and transitions into an active mode upon inputting of a P-ON (Power-ON) command from the remote control device 40. In the active mode, switching of the inputs that are displayed on the display panel 12, adjustments to the audio volume, and the like, are carried out through reception of commands transmitted from the remote control device 40. In the active mode, an electronic device outputting only audio outputs audio, an electronic device outputting only video outputs video, and an electronic device outputting audio and video outputs at least one of audio and video. In the standby mode, the electronic device outputting only audio does not output audio, the electronic device outputting only video does not output video, and the electronic device outputting audio and video does not output both of audio and video.

Moreover, an external memory 50 can be attached removably to the displaying device 10.

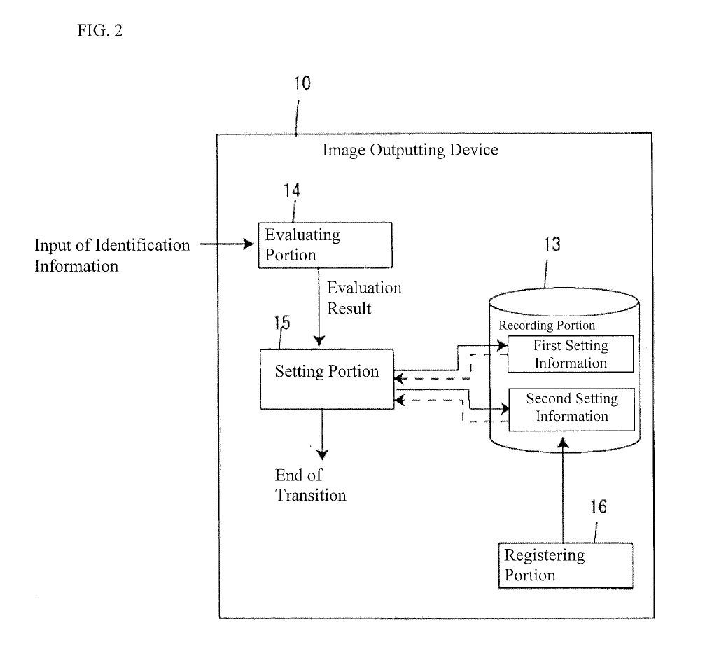

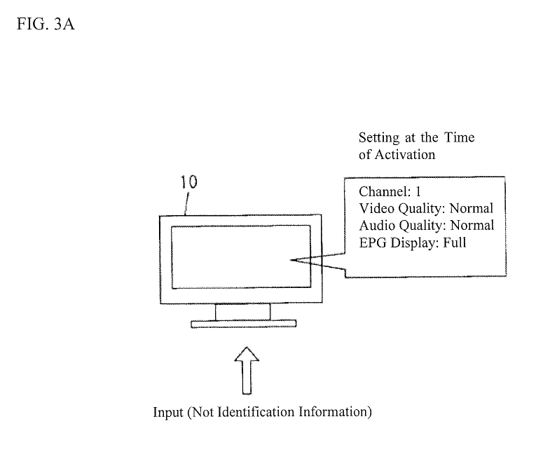

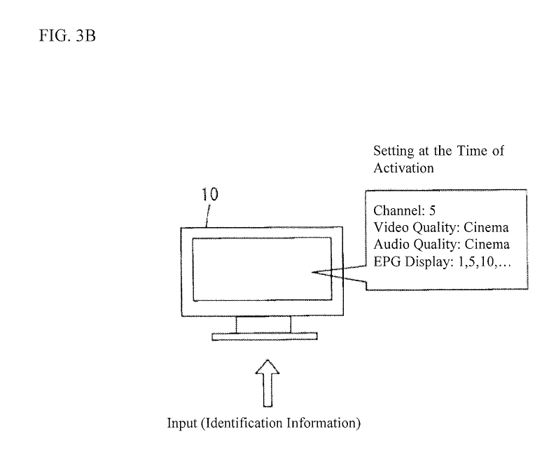

FIG. 2 shows a functional block diagram for explaining the functions of the displaying device 10 according to one or more embodiments of the present invention. Moreover, FIGS. 3A-3B show diagrams for explaining the changes when the displaying device 10 transitions from the standby mode to the active mode according to one or more embodiments of the present invention.

The displaying device 10 may comprise a recording portion 13, an evaluating portion 14, a setting portion 15, and a registering portion 16.

First, in the displaying device 10, when the user turns the power supply of the displaying device 10 OFF, the displaying device 10 transitions to the standby mode.

The evaluating portion 14 evaluates whether or not identification information (predetermined identification information) has been inputted. This evaluation may be based on a command inputted from the remote control device 40, or may be based on whether or not identification information is stored in an external memory 50 connected to the displaying device 10. Here, the identification information is information for identifying the user that has performed the input. The predetermined identification information is identification information inputted to the displaying device 10. For example, the predetermined identification information is identification information of the remote control device 40.

The setting portion 15 changes the setting at the time of activation of the displaying device 10 in response to the evaluation result by the evaluating portion 14. If the evaluating portion 14 evaluates that identification information has not been inputted, then the setting portion 15 performs the setting of the displaying device 10 based on the first setting information at the time of the transition from the standby mode to the active mode. The setting information is, for example, the setting for the video quality, the setting for the audio quality, and the channel that was most recently displayed, in the displaying device 10, along with setting values for setting up the channels displayed in an EPG (Electronic Program Guide). Moreover, the first setting information is, for example, setting values that have been stored by a last memory function.

In FIG. 3A, the setting portion 15 sets the display channel to 1, the video quality setting to “Normal,” the audio quality setting to “Normal,” and the channels displayed by the EPG to “Full” at the time of activation, applying the first setting information.

On the other hand, if the evaluating portion 14 evaluates that identification information has been inputted, then, at the time of the transition from the standby mode to the active mode, the setting portion 15 performs the setting of the displaying device 10 based on the second setting information, corresponding to that identification information. Here, the second setting information is setting values that are registered by the user through a registration procedure (described below). For example, in FIG. 3B, the setting portion 15 sets the display channel to 5, the display quality setting to “Cinema,” the audio quality setting to “Cinema,” and the channels to be displayed by the EPG to “1, 5, and 10,” at the time of activation, applying the second setting information. The second setting information may include at least a volume setting, an audio quality setting, a video quality setting, a display item setting for OSD (On Screen Display) information, a setting for a layout of an electronic program guide, and a setting for a preset channel. The setting for the preset channel is set to enable viewing of only preset channels. For example, when the channel up/channel down keys are pressed, only preset channels will appear sequentially. The display item setting for OSD information is whether or not a caption display is displayed, whether or not a channel display is always displayed, or whether or not additional information (e.g., weather information) is displayed, for example.

Here, the first and second setting information are recorded in a recording portion 13. The recording portion 13 may be an internal memory that is installed within the case 11 of the displaying device 10, or instead may be an external memory 50. The second setting information that is recorded in the recording portion 13 may be registered through a registering portion 16.

Thereafter, when the transition to the active mode has been completed, the displaying device 10 displays, for example, a specific screen.

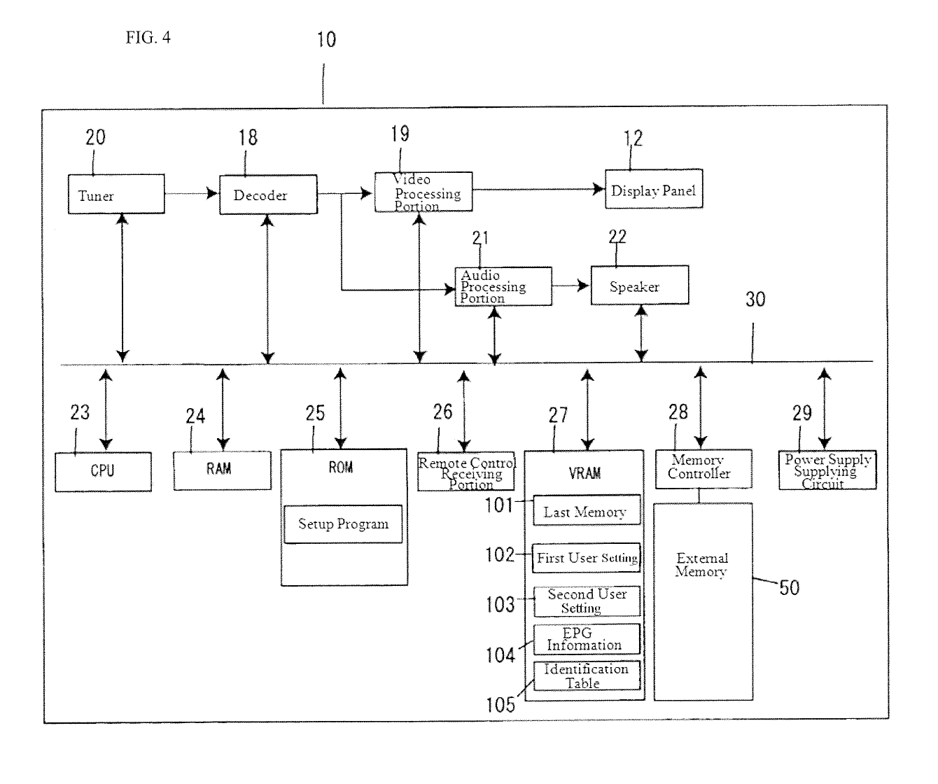

The hardware structure for the displaying device 10, by which the various functions illustrated in FIG. 2 are achieved, will be explained next. FIG. 4 shows a block diagram for explaining the hardware structure of the displaying device 10 according to one or more embodiments of the present invention. The displaying device 10 includes a tuner 20, a decoder 18, a video processing portion 19, a display panel 12, an audio processing portion 21, a speaker 22, a CPU 23 (a processor), a RAM 24, a ROM 25, a remote control receiving portion 26, a VRAM 27, a memory controller 28, a power supply supplying circuit 29, and a bus 30.

The tuner 20 receives a television broadcast signal and extracts, from the television broadcast signal, a video signal and an audio signal corresponding to the content. The decoder 18 decodes the video signal and the audio signal extracted by the tuner 20. The video processing portion 19 executes, on the video signal that has been decoded by the decoder 18, pixel count converting procedures and signal processing in accordance with the setting information. Moreover, the audio processing portion 21 performs processing in accordance with the setting information on the audio signal that has been decoded by the decoder 18.

The output side of the video processing portion 19 is connected to the display panel 12. The display panel 12 displays video based on the video signal that has been subjected to signal processing by the video processing portion 19. The display panel 12 is, for example, a liquid crystal panel or an organic EL panel. The image outputting portion in one or more embodiments is achieved through the video processing portion 19 and the display panel 12.

The output side of the audio processing portion 21 is connected to the speaker 22. The speaker 22 outputs audio based on the audio signal that has been subjected to signal processing by the audio processing portion 21.

While in FIG. 4 the speaker 22 is shown as a portion of the displaying device 10, the speaker 22 may instead be a device separate from the displaying device 10. The audio outputting portion in one or more embodiments is achieved through the audio processing portion 21 and the speaker 22.

The CPU 23 is connected through a bus 30 to the various portions of the displaying device 10, and controls over all the driving of the displaying device 10. Moreover, according to one or more embodiments the evaluating portion 14, the setting portion 15, and the recording portion 16 may be achieved or executed by the CPU 23, through deploying, into a RAM 24, and executing a setup program that is stored in the ROM 25.

Moreover, a VRAM 27 is connected to the bus 30. The VRAM 27 stores a last memory 101, a first user setting 102, a second user setting 103, EPG information 104, and an identification table 105. In the present embodiment, the VRAM 27 functions as the recording portion 13. Moreover, the last memory 101 is the first setting information, where the first user setting 102 or the second user setting 103 is the second setting information. The identification table 105 is a table that defines the correspondence between identification information and the first user setting 102 and the second user setting 103.

Moreover, the displaying means in one or more embodiments is achieved through the CPU 23 displaying an EPG on the display panel 12 based on EPG information 104.

Moreover, a remote control receiving portion 26, for receiving commands from the remote control device 40, and a memory controller 28, to which an external memory 50 can be connected removably, are connected to the bus 30. The remote control receiving portion 26 converts, into commands, signals from the remote control device 40, and outputs them through the bus 30 to the CPU 23. The signals received by the remote control receiving portion 26 are, for example, infrared signals or RF (Radio Frequency) signals.

Furthermore, when the remote control device 40 is embodied through a mobile terminal (an external device), such as a smart phone, the displaying device 10 may comprise a LAN module that is able to perform wireless communication with the mobile terminal.

Furthermore, a power supply supplying circuit 29, for supplying the power to the various portions of the displaying device 10, is connected to the bus 30. The power supply supplying circuit 29 supplies power to the various portions through power supply lines, not shown. The power that is supplied to the various portions may be changed to a low voltage through a function of the CPU 23 when there is a transition from the active mode to the standby mode.

### (2) Method for Registering the Setting Information According to One or More Embodiments of the Present Invention

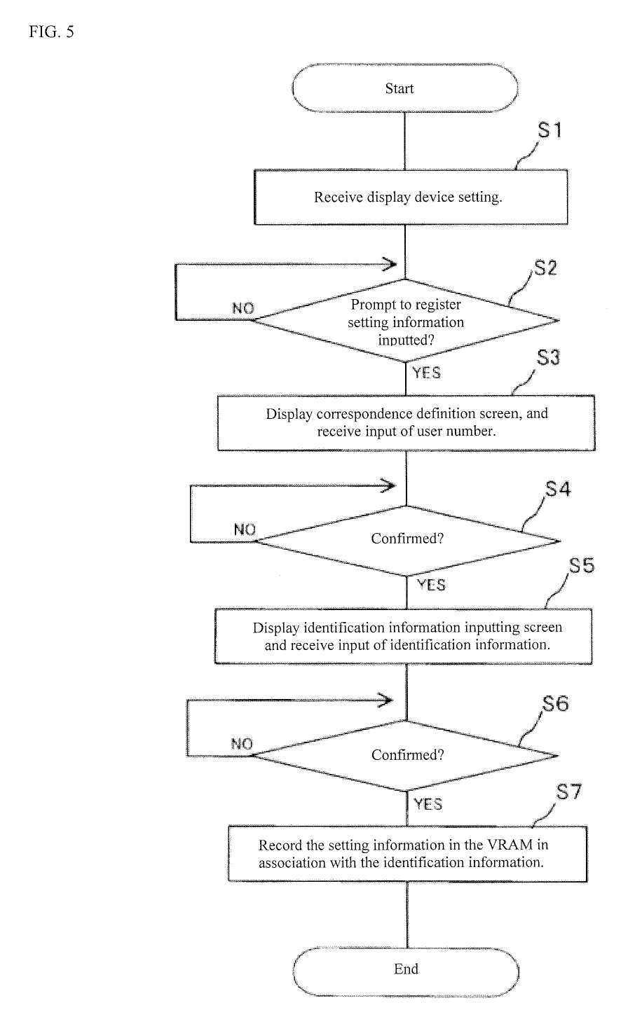

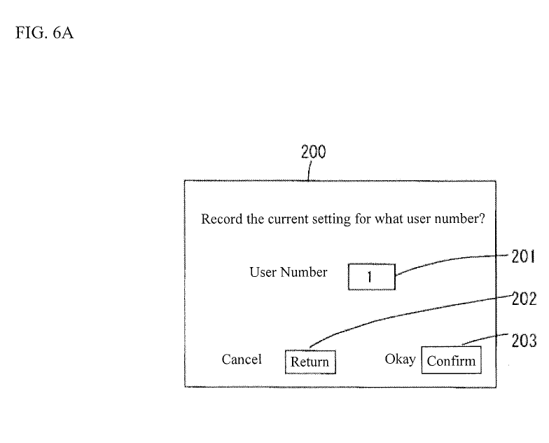

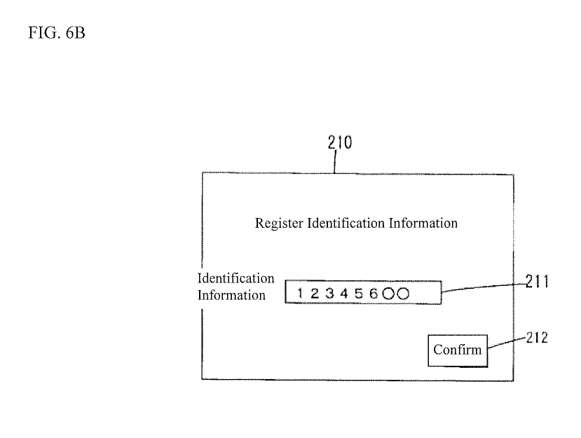

The procedures for registering the setting information, executed by the registering portion 16 of the displaying device 10, will be explained next. FIG. 5 shows a flowchart illustrating the procedures that are executed by the registering portion 16 of the displaying device 10 according to one or more embodiments of the present invention. FIGS. 6A-6B show diagrams illustrating a screen that is displayed on the displaying device 10 according to one or more embodiments of the present invention. The flowchart shown in FIG. 5 explains an example of a case wherein a first user setting 102 is stored in the VRAM 27 of the displaying device 10.

When the user operates the remote control device 40 to input, into the displaying device 10, settings that are to be registered as the first user setting 102, then the CPU 23 receives this input in Step S1. When, for example, the displaying device 10 is activated in this Step S1, then the channel that is displayed first when the displaying device 10 is activated, the video quality, the audio quality, and the channels to be displayed in the EPG are selected.

When the user operates the remote control device 40 to perform an input that prompts the current setting of the displaying device 10 to be registered as the first user setting (setting information) (Step S2: YES), the CPU 23 advances to Step S3.

In Step S3, the CPU 23 displays, on the display panel 12, a correspondence defining screen 200, and receives inputting of a user number. The correspondence defining screen 200 is a screen through which the user may input the user number for which the correspondence to the current setting in the displaying device 10 is to be registered. Note that the user number is information for identifying the user. A box icon 201 into which the user number that corresponds to the current setting of the displaying device 10 is to be inputted, a “Back” icon 202 for canceling the input, and a “Confirm” (“OK”) icon 203, for confirming the input, are each shown in the correspondence defining screen 200, as illustrated in FIG. 6A. In the example discussed below, it will be assumed that the user has inputted “1” into the box icon 201 in order to register the current setting for the displaying device 10 as the first user setting.

When the user operates the remote control device 40 to operate the icon 203 to confirm the registration of the user number (Step S4: YES), processing advances to Step S5.

In Step S5, the CPU 23 displays an identification information inputting screen 210, for registering user information, on the display panel 12. An icon 211 for inputting an operation inputting to inform the user of the identification information in the displaying device 10 is displayed in the identification information displaying screen 210, as illustrated in FIG. 6B. Moreover, a Done key 212, for completing the registration using the identification information inputting screen 210, is displayed.

In this first example, the registering portion 16 uses a combination of inputs of the operating keys of the remote control device 40 as the identification information. As a result, the user operates the remote control device 40 to perform the inputting through the icon 211. For example, in FIG. 6B, the user inputs, as identification information, the channel keys “1”, “2”, “3”, “4”, etc., as combinations of inputs of operating keys.

When the user operates the icon (“Done”) 212, displayed in the identification information inputting screen 210, to confirm the registration of the identification information (Step S6: YES), processing advances to Step S7. In Step S7, the CPU 23 updates the identification table 105 recorded in the VRAM 27. Specifically, the CPU 23 records, in the identification table 105, the setting information recorded in Step S1 in association with the identification information inputted in Step S5.

### (3) Method for Activating According to One or More Embodiments of the Present Invention

The method for activating the displaying device 10 according to one or more embodiments of the present invention will be explained next.

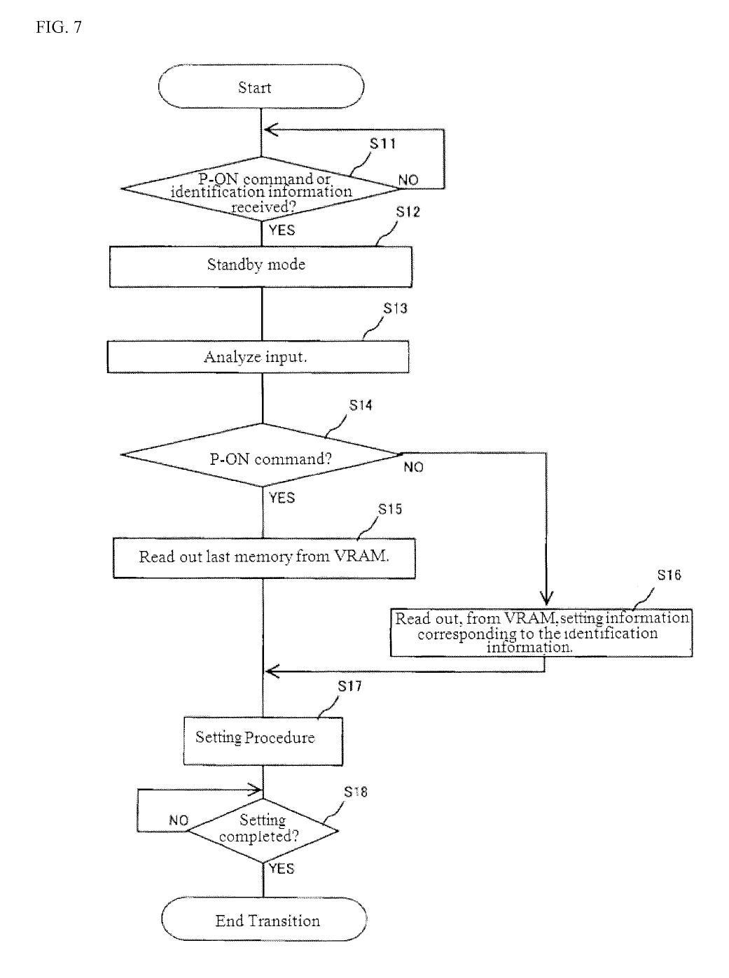

FIG. 7 shows a flowchart for explaining the procedures that are executed in response to when the displaying device 10 is activated according to one or more embodiments of the present invention.

The displaying device 10, in the standby mode, monitors for an input from the remote control device 40.

When the remote control receiving portion 26 receives an input of a P-ON command or identification information from the remote control device 40 (Step S11: YES), then, in Step S12, the standby mode is maintained.

In Step S13, the CPU 23 analyzes the input that has been received. The method by which the CPU 23 performs this analysis is to perform the analysis based on the identification table 105 that is recorded in the VRAM 27.

If the input that has been analyzed is a P-ON command (Step S14: YES), then processing advances to Step S15, and the CPU 23 reads out the last memory 101 that is stored in the VRAM 27.

In Step S17, the CPU 23 performs the setting of the displaying device 10 based on the setting information that has been read out (the last memory 101). Specifically, the setting values in the last memory 101, which record the setting information at the time of P-OFF, are applied.

On the other hand, if the input that has been analyzed is not a P-ON command (Step S14: NO), then processing advances to Step S16, and the CPU 23 reads out, from the VRAM 27, the setting information 102 or 103 that correspond to the identification information that has been analyzed. As one example, when the displaying device 10 receives, from the remote control device 40, identification information corresponding to the user number “1”, the CPU 23 reads out, from the VRAM 27, the first user setting 102, which is the setting information corresponding to that identification information.

In Step S17, the CPU 23 performs the setting of the displaying device 10 based on the setting information that has been read out (the first user setting 102). Specifically, the setting values in the first user setting 102, which were registered by the user through the registration procedure, are applied.

When the setting of the displaying device 10 has been completed (Step S18: YES), then the CPU 23 completes the transition to the active mode. In this mode an image (a channel), for example, is displayed on the display panel 12.

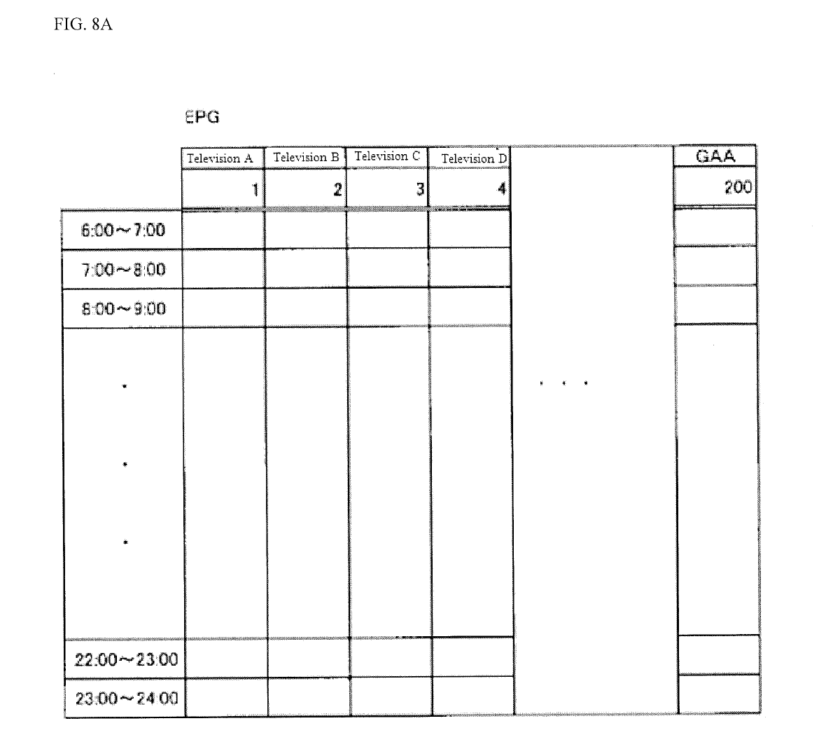

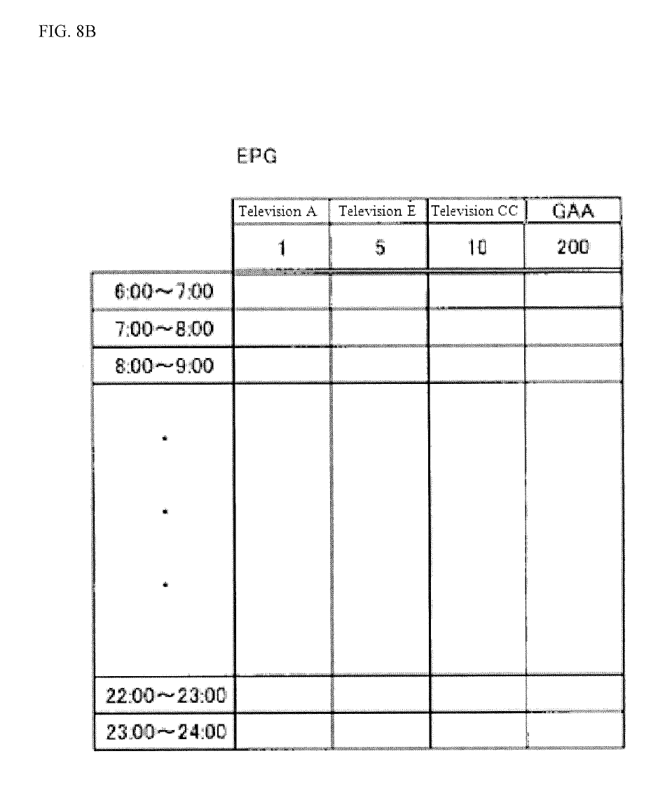

FIGS. 8A-8B show diagrams for explaining changes in the setting in the displaying device 10 according to one or more embodiments of the present invention. FIGS. 8A-8B show, as one example, changes in the EPG information that is displayed on the screen. FIG. 8A shows an EPG that is displayed on the screen through the settings in the last memory 101. FIG. 8B shows an EPG that is displayed on the screen through the settings in the first user setting 102.

The user operates the remote control device 40 to input a P-ON command, to activate the displaying device 10. At this time, if the settings in the last memory 101 set the EPG display channels to “Full,” then when the user operates the remote control device 40 to display the EPG, then program guides corresponding to all of the channels will be displayed as the EPG, as illustrated in FIG. 8A.

On the other hand, the user operates the remote control device 40 to input identification information into the displaying device 10, to activate the displaying device 10. In this case, if the setting information sets the EPG display channels to “1”, “5”, “10”, and “200”, then when the user operates the remote control device 40 to display the EPG, then, as illustrated in FIG. 8B, program guides corresponding to the channels “1”, “5”, “10”, and “200”, registered in the setting information, will be displayed as the EPG.

As explained above, in this first example, if identification information is inputted when in the standby mode, then at the transition from the standby mode to the active mode the setting of the video output device will be carried out based on the second setting information that corresponds to the identification information. Because of this, the setting that is desired by the user can be carried out without the user changing the setting after activation of the device.

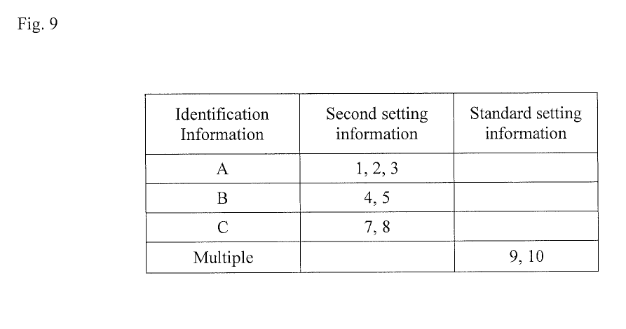

Setting information that is stored in advance as standard setting information may be provided in the recording portion 13, and when a plurality of identification information is inputted, the setting portion 15 performs the setting based on the standard setting information. FIG. 9 shows a diagram for explaining the second setting information and the standard setting information related to the identification information in the displaying device 10 according to one or more embodiments of the present invention.

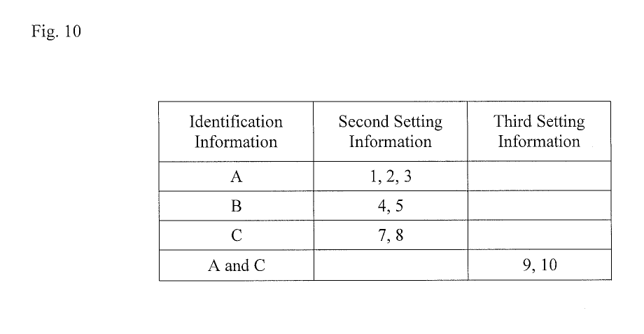

The recording portion 13 may include third setting information corresponding to a plurality of identification information. When a plurality of identification information is inputted, the setting portion 15 performs the setting based on the third setting information. FIG. 10 shows a diagram for explaining the second setting information and the third setting information related to the identification information in the displaying device 10 according to one or more embodiments of the present invention.

Here, the third setting information may be information in which shared setting values for individual settings are set in individual setting items for the second setting information corresponding to a plurality of identification information corresponding to the third setting information. For example, the identification information “A” is related to the second setting information “Audio quality normal, Video quality normal, Audio volume 10, Preset channels 1, 2.” The identification information “B” is related to the second setting information “Audio quality normal, Video quality cinema, Audio volume 20, Preset channels 1, 2, 3.” The identification information “C” is related to the second setting information “Audio quality normal, Video quality normal, Audio volume 30, Preset channels 1, 4.” When a plurality of identification information “A and C” is inputted, the third setting information related to the identification “A and C” is set to “Audio quality normal, Video quality normal” because the identification information “A” and “C” have setting items “Audio quality normal, Video quality normal” of the second setting information respectively.

On the other hand, the setting information may be a maximum value or a minimum value of the setting information corresponding to the each information of the plurality of identification information.

On the other hand, the third setting information may be information in which average values for individual settings are set in individual setting items for the second setting information corresponding to a plurality of identification information corresponding to the third setting information. For example, when a plurality of identification information “A and C” is inputted, the third setting information related to the identification “A and C” is set to “Audio volume 20” because the average value is “Audio volume 20” among the setting value “Audio volume 10” of the identification information “A” and the setting value “Audio volume 30” of the identification information “C” in the above example.

On the other hand, the third setting information may be information in which setting values including the setting values for all individual settings are set in individual setting items for the second setting information corresponding to a plurality of identification information corresponding to the third setting information. For example, when a plurality of identification information “A and C” is inputted, the third setting information related to the identification “A and C” is set to “Preset channels 1, 2, 4” because the setting value for all individual settings is “Preset channels 1, 2, 4” among the setting value “Preset channels 1, 2” of the identification information “A” and the setting value “Preset channels 1, 4” of the identification information “C” in the above example.

### 2. Second Example

In the second example, the structure is one in which the setting information corresponding to the identification information is recorded in an external memory 50, differing from those of the other embodiments. Specifically, the recording portion 13 is structured from an external memory 50, which is connected removably to the displaying device 10, in addition to the VRAM 27 that is installed within the displaying device 10.

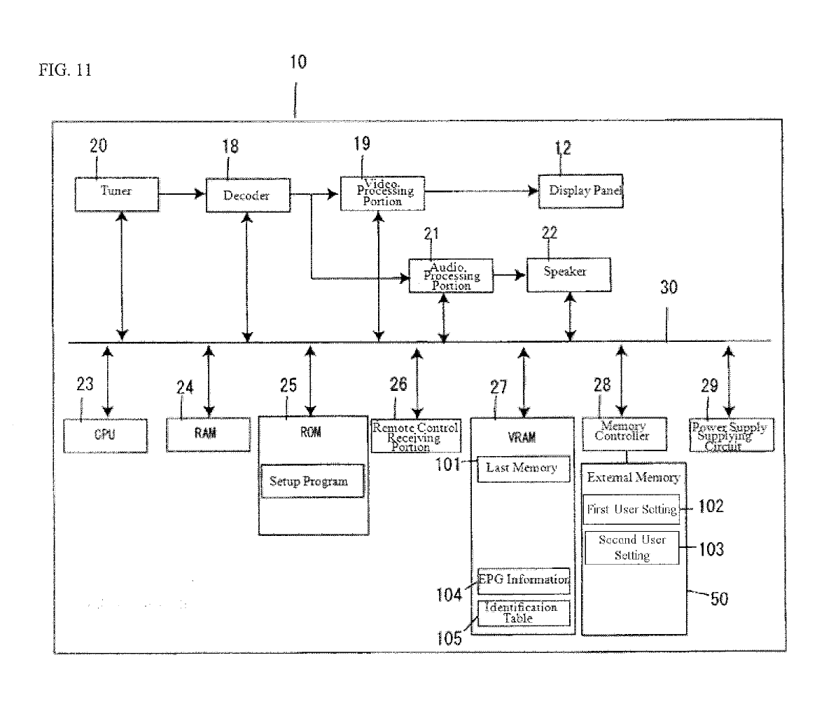

FIG. 11 shows a block diagram for explaining the hardware structure of the displaying device 10 according to one or more embodiments of the present invention. Those parts that are assigned identical reference numbers are structures that are similar to those in the first example, and explanations thereof are omitted.

The displaying device 10, illustrated in FIG. 11, includes a tuner 20, a decoder 18, an image processing portion 19, a display panel 12, an audio processing portion 21, a speaker 22, a CPU 23, a RAM 24, a ROM 25, a remote control receiving portion 26, a VRAM 27, a memory controller 28, a power supply supplying circuit 29, and a bus 30.

The external memory 50 is connected removably to the memory controller 28. When the external memory 50 is connected, the memory controller 28 outputs a detected signal through the bus 30 to the CPU 23. Moreover, a first user setting 102 and a second user setting 103 are recorded in the external memory 50. This first user setting 102 and this second user setting 103 are the same as those in the first example, where setting values are recorded through functions of the CPU 23 (the registering portion 16). On the other hand, the last memory 101 is recorded in the VRAM 27.

Because of this, in the second example the recording portion 13 may be achieved through the external memory 50 and the VRAM 27.

The method for activating the displaying device 10 according to one or more embodiments of the present invention will be explained next.

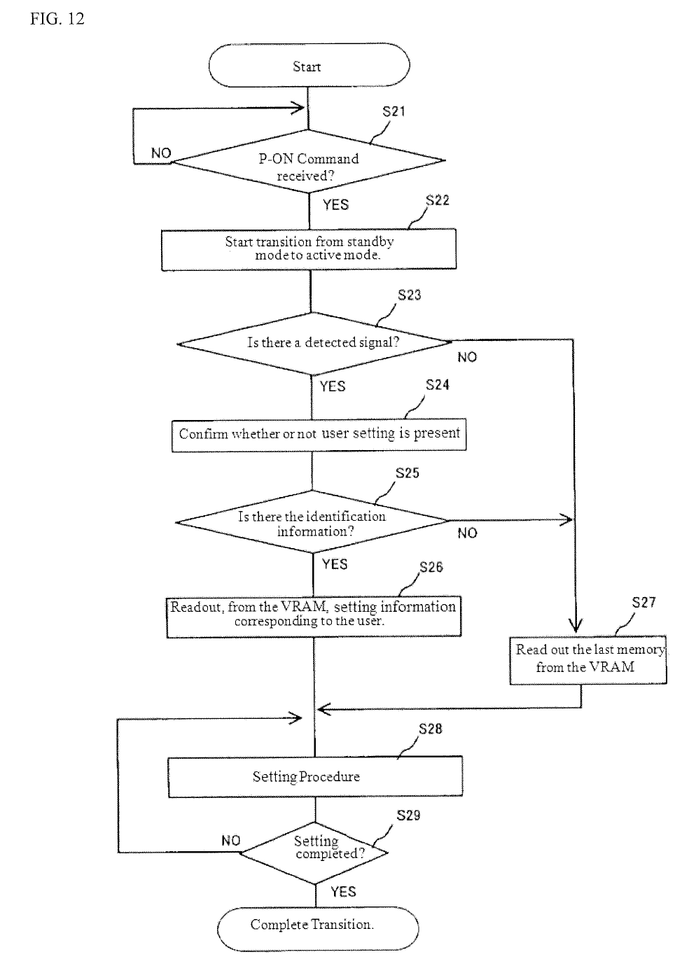

FIG. 12 shows a flowchart for explaining the procedure for carrying out activation of the displaying device 10 according to one or more embodiments. The description below will assume that the first user setting 102 is recorded in the external memory 50.

The displaying device 10, in the standby mode, monitors for an input from the remote control device 40.

When the remote control receiving portion 26 receives a P-ON command from the remote control device 40 (Step S21: YES), processing advances to Step S22, and the CPU 23 starts the transition from the standby mode to the active mode.

If the external memory 50 is connected and the CPU 23 receives a detected signal (Step S23: YES), then, in Step S24, the CPU 23 confirms the first user setting 102 (the setting information) that is stored in the external memory 50. That is, if, in the second example, setting information is recorded in the external memory 50, then there is an evaluation that identification information is inputted.

If the first user setting 102 is recorded in the external memory 50 (Step S25: YES), then, in Step S26, the CPU 23 reads out, from the external memory 50, the first user setting 102 that is recorded in the external memory 50. If a plurality of user settings are recorded in the external memory 50, then the CPU 23, after analyzing the individual setting information, may read out setting information from the external memory 50 depending on the analysis results.

On the other hand, if the first user setting 102 is not recorded in the external memory 50 (Step S25: NO), then, in Step S27, the CPU 23 reads out the last memory 101 that is recorded in the VRAM 27.

In Step S28, the CPU 23 performs the setting of the displaying device 10 based on the first user setting 102 that has been read out. Specifically, the setting is performed through the setting information that is recorded in the external memory 50 or the VRAM 27.

When the setting of the displaying device 10 has been completed (Step S29: YES), then the CPU 23 completes the transition to the active mode. A screen (channel) is displayed on the display panel 12, for example, in the same manner as in the first example.

As explained above, when, in the second example, setting information is recorded in the external memory 50, which is attached removably, the setting can be performed for each individual user based on this setting information, which may enable an improvement in convenience.

### 3. Third Example

When a mobile terminal, such as a smart phone, is equipped with a function as a remote control device for operating the displaying device 10, then information included in a command that is outputted from the mobile terminal through a LAN may be used as the identification information.

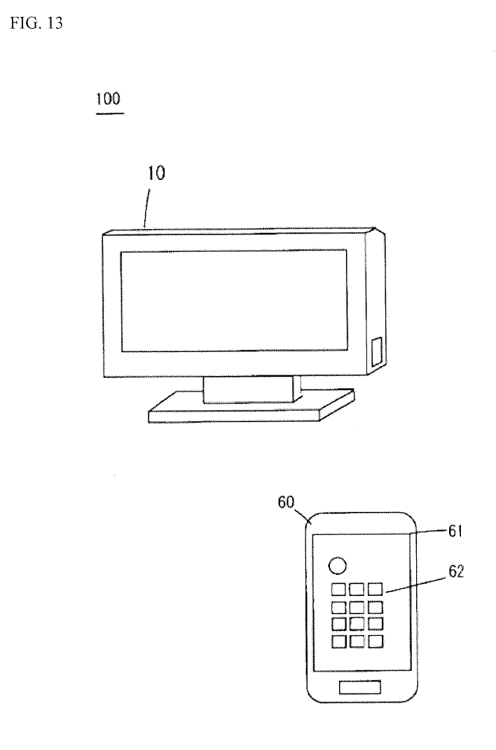

FIG. 13 shows an external view of a video output system 100 according to one or more embodiments of the present invention. As illustrated in FIG. 13, the video output system 100 has a displaying device 10, as a video output device, and a mobile terminal 60, which functions as a remote control device. As one example, the displaying device 10 and the mobile terminal 60 are connected through a wireless LAN. Moreover, the displaying device 10 is equipped with a LAN module for carrying out communications with the mobile terminal 60.

Of course, the LAN for connecting the displaying device 10 and the mobile terminal 60 may be of any form, including those that are not wireless.

The mobile terminal 60 is arranged so that a touch panel 62 is exposed on front surfaces of a case 61. Given this, operating keys for operating the displaying device 10 may be displayed on the touch panel 62. Additionally, the user can operate the touch panel 62 of the mobile terminal 60 to switch the power supply of the displaying device 10 ON/OFF, to switch the channels, to operate the EPG display, and so forth.

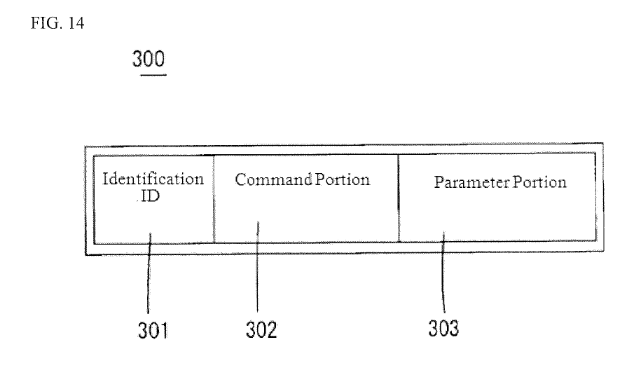

FIG. 14 shows a diagram illustrating a structure of a command outputted from the mobile terminal 60 according to one or more embodiments of the present invention.

The command 300 may comprise an identification ID portion 301, a command portion 302, and a parameter portion 303. The identification ID portion 301 is structured from the MAC address set in the mobile terminal 60. Moreover, the command portion 302 is structured from information indicating the type of command. Furthermore, the parameter portion 303 is structured from parameters for the command.

According to one or more embodiments of the present invention, the information recorded in the identification ID 301 may function as the identification information.

The method for activating the displaying device 10 according to one or more embodiments of the present invention will be explained next.

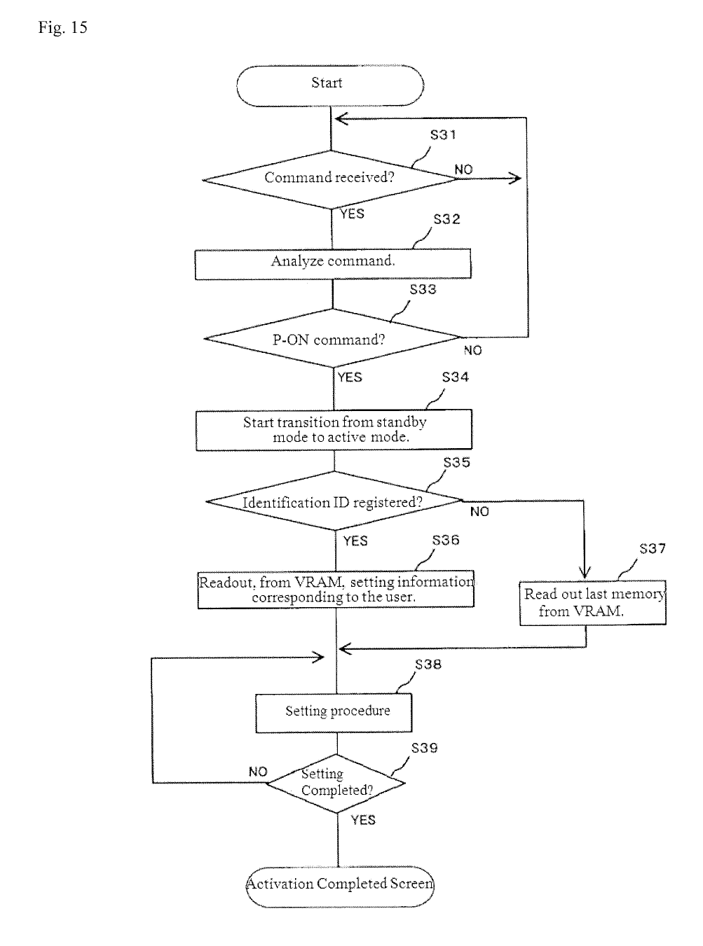

FIG. 15 shows a flowchart for explaining the procedures executed when the displaying device 10 is activated according to one or more embodiments of the present invention. In the procedures illustrated in FIG. 15, information corresponding to a first user setting 102, recorded in the identification table 105, is recorded in the identification ID 301.

The displaying device 10, in the standby mode, monitors for a command from the mobile terminal 60. When a command from the mobile terminal 60 is received by the CPU 23 through the LAN module (Step S31: YES), then, in Step S32, the CPU 23 analyzes the command that has been received. Specifically, the CPU 23 analyzes the identification ID 301 and the command portion 302 of the command 300.

If the command portion 302 of the command 300 is a P-ON command (Step S33: YES), then processing advances to Step S34, and the CPU 23 begins the transition from the standby mode to the active mode. If the command portion 302 is not a P-ON command (Step S33: NO), then the command sent from the mobile terminal 60 is ignored.

Given this, in Step S35 the CPU 23 evaluates whether or not the identification ID 301 is registered in the identification table 105. If the identification ID is not registered (Step S35: NO), then processing advances to Step S37, and the CPU 23 reads out the last memory 101 that is recorded in the VRAM 27. In Step S38, the CPU 23 performs the setting of the displaying device 10 based on the last memory 101 that has been read out.

On the other hand, if the identification ID 301 is registered in the identification table 105 (Step S35: YES), then the CPU 23 advances to Step S36 and reads out, from the VRAM 27, the first user setting 102 that corresponds to the user that corresponds to the identification ID. In Step S38, the CPU 23 performs the setting of the displaying device 10 based on the first user setting 102 that has been read out.

If the setting of the displaying device 10 has been completed (Step S39: YES), then the CPU 23 completes the transition to the active mode. For example, in the same manner as in the first example, an image (a channel) is displayed on the display panel 12.

As described above, in this third example, one or more embodiments of the invention may be achieved through a command sent from a mobile terminal 60.

### 4. Other Examples

The memory may store history information of a viewing time band for each identification information. The history information is information that indicates when (a day of the weeks and/or a time of day) the processor transitions to the active mode and/or when (a day of the week and/or a time of day) the processor transitions to the standby mode.

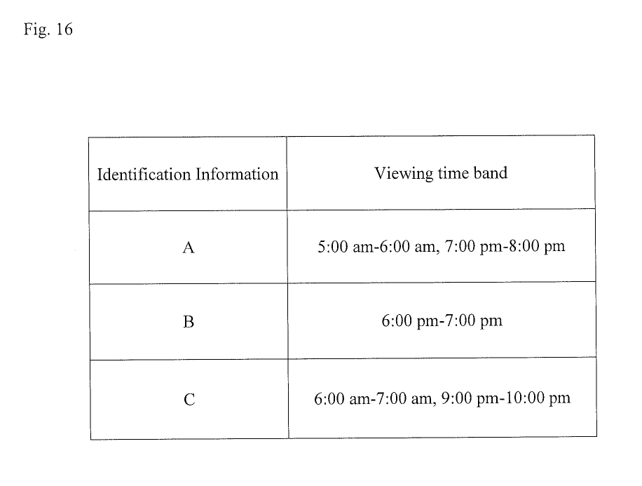

FIG. 16 shows a diagram for explaining the history information of the viewing time band related to the identification information in the displaying device 10 according to one or more embodiments of the present invention. The setting information (predetermined setting information) is generated based on the history information of the identification information when transitioning to an active mode.

The standby mode may be maintained while the predetermined identification information is inputted to the electronic device.

The explanation using the displaying device as an example is no more than one example as a video output device. The video output device may be achieved through a recorder that is equipped with a recording portion, such as an HDD, or through a mobile terminal.

Furthermore, the setting information that can be registered by the user is not limited to that which is described in embodiments set forth above. For example, if the video output device is a displaying device, the setting information may be information that limits the viewing of the content to the user.

The present invention is not limited to embodiments described above. One or more embodiments of the present invention may include one or more of the following:

Applications where there are changes in the combinations of those materials, structures, and the like that are interchangeable, disclosed in one or more of the embodiments described above;

Applications where there are modifications in the materials, structures, or the like, or in combinations thereof, that are interchangeable, where the materials, structures, or the like, disclosed in one or more of the embodiments set forth above, are replaced with materials, structures, and the like that are interchangeable that, although not disclosed in embodiments set forth above, are known technologies; and

Applications where materials, structures, and the like are replaced, or combinations modified, wherein one skilled in the art can envision a replacement of a material, structure or the like from an embodiment set forth above, based on known technologies, although not disclosed in embodiments set forth above.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

10: Displaying Device
11: Case
12: Display Panel
13: Recording Portion
14: Evaluating Portion
15: Setting Portion
16: Registering Portion
18: Decoder
19: Video Processing Portion
20: Tuner
21: Audio Processing Portion
22: Speaker
23: CPU
24: RAM
25: ROM
26: Remote Control Receiving Portion
27: VRAM
28: Memory Controller
29: Power Supply Supplying Circuit
30: Bus
40: Remote Control Device
50: External Memory
60: Mobile Terminal
61: Case
62: Touch Panel
100: Video output system
101: Last Memory
102: First User Setting
103: Second User Setting
104: EPG Information
105: Identification Table

What is claimed is:

1. An electronic device comprising:
a memory that stores setting information corresponding to at least identification information; and
a processor that changes a setting of the electronic device to a changed setting based on setting information corresponding to predetermined identification information in a standby mode.

2. The electronic device according to claim 1, wherein the processor causes the electronic device not to output audio in the standby mode.

3. The electronic device according to claim 1, wherein the setting information includes at least one of a volume setting, an audio quality setting, a video quality setting, a display item setting for OSD information, a setting for a layout of an electronic program guide, and a setting for a preset channel.

4. The electronic device according to claim 1, wherein the processor causes the electronic device to transition from the standby mode to an active mode based on the changed setting.

5. The electronic device according to claim 1, wherein the processor changes the setting of the electronic device based on other setting information.

6. The electronic device according to claim 1, wherein the setting information stored in the memory corresponds to a plurality of identification information.

7. The electronic device according to claim 6, wherein the setting information is based on setting information corresponding to each identification information of the plurality of identification information.

8. The electronic device according to claim 7, wherein the setting information is an average value of the setting information corresponding to the each identification information of the plurality of identification information.

9. The electronic device according to claim 7, wherein the setting information is a maximum value or a minimum value of the setting information corresponding to the each information of the plurality of identification information.

10. The electronic device according to claim 7,
wherein the setting information includes a preset channel and includes all of the preset channels included in the setting information corresponding to the each identification information of the plurality of identification information.

11. The electronic device according to claim 1, wherein the processor changes to predetermined setting information based on a transition from an active mode to the standby mode.

12. The electronic device according to claim 11, wherein the predetermined setting information is generated based on history information of the identification information when transitioning to the active mode.

13. The electronic device according to claim 12, wherein the history information is identification information based at least on a day of the week or a time of day.

14. The electronic device according to claim 11, wherein the processor causes the electronic device to transition to the active mode based on the predetermined setting information when the memory does not store the identification information corresponding to the predetermined identification information.

15. The electronic device according to claim 1, wherein the predetermined identification information is identification information of an external device.

16. The electronic device according to claim 1, wherein the predetermined identification information is identification information of a remote control device.

17. The electronic device according to claim 1, wherein the standby mode is maintained while the predetermined identification information is inputted to the electronic device.
